(19) United States
(12) Patent Application Publication
(10) Pub. No.: US 2006/0030347 A1
(43) Pub. Date: Feb. 9, 2006

(54) Virtual push to talk (PTT) and push to share (PTS) for wireless communications systems

(76) Inventor: Deepankar Biswaas, Bangalore (IN)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/183,516

(22) Filed: Jul. 18, 2005

Related U.S. Application Data
(60) Provisional application No. 60/588,464, filed on Jul. 16, 2004.

(51) Int. Cl. H04Q 7/20

(52) U.S. Cl. 455/518; 455/414.1

(57) ABSTRACT

Advanced voice services known as “Virtual Push-to-Talk” and “Push-to-Share” for wireless communications systems. A Real-Time Exchange (RTX) interfaces to the wireless network to provide these advanced voice services.

### CROSS REFERENCE TO RELATED APPLICATIONS

This application claims the benefit under 35 U.S.C. Section 119(e) of the following co-pending and commonly-assigned patent application:
U.S. Provisional Patent Application Ser. No. 60/588,464, filed Jul. 16, 2004, by Deepankar Biswaas, entitled “VIRTUAL PUSH TO TALK (PTT) AND PUSH TO SHARE (PTS),” attorney docket number G&C 154.17-US-P1;
which application is incorporated by reference herein.

This application is related to the following co-pending and commonly-assigned patent applications:
U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, which application claims the benefit under 35 U.S.C. Section 365 of PCT International Patent Application Serial Number PCT/US03/16386 (154.4-WO-U1), which application claims the benefit under 35 U.S.C. Section 119(e) of U.S. Provisional Patent Application Ser. Nos. 60/382,981 (154.3-US-P1), 60/383,179 (154.4-US-P1) and 60/407,168 (154.5-US-P1);
PCT International Patent Application Number PCT/US04/23038, filed Jul. 16, 2004, by F. Craig Farrill, Bruce D. Lawler and Krishnakant M. Patel, entitled “PREMIUM VOICE SERVICES FOR WIRELESS COMMUNICATIONS SYSTEMS,” attorney docket number 154.7-WO-U1, which application claims the benefit under 35 U.S.C. Section 119(e) of U.S. Provisional Patent Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Section 119, 120 and/or 365 of PCT International Patent Application Serial Number PCT/US03/16386 (154.4-WO-U1);
U.S. patent application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” attorney docket number 154.9-US-U1, which application claims the benefit under 35 U.S.C. Section 119(e) of U.S. Provisional Patent Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility patent application Ser. No. 10/515,556 (154.4-US-WO) and PCT International Patent Application Serial Number PCT/US04/23038 (154.7-WO-U1);
U.S. Utility patent application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, which application claims the benefit under 35 U.S.C. Section 119(e) of U.S. Provisional Patent Application Ser. No. 60/571,075 (154.10-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);
U.S. Utility patent application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, which application claims the benefit under 35 U.S.C. Section 119(e) of U.S. Provisional Patent Application Ser. Nos. 60/573,059(154.11-US-P1) and 60/576,092 (154.12-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/129,268 (154.10-US-U1); and
U.S. Utility patent application Ser. No. 11/136,233, filed May 24, 2005, by Krishnakant M. Patel, Vyankatesh Vasant Shanbhag, and Anand Narayanan, entitled “SUBSCRIBER INFORMATION MODULE (SIM) ENABLING ADVANCED VOICE SERVICES (AVS) INCLUDING PUSH TO TALK ON WIRELESS HANDSETS AND NETWORKS,” attorney docket number 154.13-US-U1, which application claims the benefit under 35 U.S.C. Section 119(e) of U.S. Provisional Patent Application Ser. No. 60/573,780 (154.13-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/134,883 (154.11-US-U1); and
U.S. Utility patent application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, which application claims the benefit under 35 U.S.C. Section 119(e) of U.S. Provisional Patent Application Ser. No. 60/581,954 (154.16-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);
all of which applications are incorporated by reference herein.

### BACKGROUND OF THE INVENTION

1. Field of the Invention

This invention relates in general to wireless communications systems, and more specifically, to advanced voice services known as “Virtual Push-to-Talk” and “Push-to-Share” for wireless communications systems.

2. Description of Related Art

Advanced voice services (AVS), such as two-way half-duplex voice calls within a group, also known as “Press-to-Talk,” “Push-to-Talk,” PTT or P2T, have enormous revenue earnings potential for wireless networks, such as cellular networks and personal communications systems (PCS) networks.

Currently, there are three major approaches employed in providing advanced voice services such as P2T in wireless networks. One approach requires the installation of a dedicated private network, parallel to the wireless network, to support the group-based voice services. NEXTEL uses such a system, based on a solution developed by MOTOROLA known as IDEN. However, a dedicated private network is costly to install and maintain and is employed by a few public wireless carriers. Also, the IDEN system is non-standard, and hence cannot be used in standard wireless communications networks, such as those based on GSM (Global System for Mobile Communications) and CDMA (Code Division Multiple Access).

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless networks based on existing standards, such as GSM, CDMA, etc. However, even for the newer standards, solutions based on VoIP have serious drawbacks, including slower call setup, significant overhead, increased susceptibility to packet losses, low bit rate voice coders, and significant modifications to the mobile handset. There is a need, instead, for solutions that require only minimal upgrades to the handset.

Still another approach is that defined in co-pending and commonly-assigned P.C.T. utility patent application Serial Number PCT/US03/16386, filed on May 23, 2003, by Gorachand Kundu, Ravi Ayyasamy, and Krishnakant Patel, entitled DISPATCH SERVICE ARCHITECTURE FRAMEWORK, attorneys' docket number 154.4-WO-U1, which application is incorporated by reference herein. In this approach, group-based voice services are provided by a dispatch gateway or real-time exchange that interfaces to the wireless network to provide the group-based voice services therein, wherein both the dispatch gateway and mobiles that use the group-based voice services communicate with each other using call setup and in-band signaling within the wireless network.

Notwithstanding these innovations, there is a need in the art for other advanced voice services that comply with existing and emerging wireless standards and provide superior user experiences. The present invention aims to satisfy this need by providing advanced voice services known as “Virtual Push-to-Talk” and “Push-to-Share” for wireless communications systems.

### SUMMARY OF THE INVENTION

To overcome the limitations in the prior art described above, and to overcome other limitations that will become apparent upon reading and understanding the present specification, the present invention discloses advanced voice services known as “Virtual Push-to-Talk” and “Push-to-Share” for wireless communications systems. A real-time exchange (RTX) interfaces to the wireless network to provide these advanced voice services.

### BRIEF DESCRIPTION OF THE DRAWINGS

Referring now to the drawings in which like reference numbers represent corresponding parts throughout:

FIG. 1 is a block diagram that illustrates an exemplary embodiment of the dispatch services architecture framework according to a preferred embodiment of the present invention;

FIG. 2 illustrates a proposed architecture for the real-time exchange according to the preferred embodiment of the present invention;

FIG. 3 is a state diagram that illustrates the operation of a “Press-to-Connect” call according to a preferred embodiment of the present invention.

FIG. 3 is a flowchart that illustrates the operation requirements of the Virtual Push-to-Talk (PTT) according to the preferred embodiment of the present invention.

FIG. 4 illustrates a system architecture for the Push-to-Share (PTS) service according to the preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention comprises an advanced voice service (AVS), known as “Virtual Push-to-Talk” and “Push-to-Share” for wireless communications systems.

These services can be added to any wireless communications network, including CDMA, GSM, UMTS, and others. Moreover, these services are applicable to all commercial wireless radio frequency bands, and can be applied to any commercial, private, public, military and government radio frequency band in use around the world.

These services can also be delivered across any existing and future brand of wireless infrastructure that employs telecommunications industry standard signaling and transmission standards, such as Signaling System 7 (SS7) and PCM channels such as T1 and E1 digital trunk connections. Currently, wireless infrastructure from suppliers such as Ericsson, Nokia, Motorola, Lucent, Nortel, Siemens and Alcatel can be upgraded by adding the RTX to the core network and connecting the RTX through transmission facilities to the Mobile Switching Centers (MSCs).

In addition, these services can be implemented in digital wireless networks in any part of the world. The technology is applicable to any commercial mobile operator in all seven regions of the globe.

Also, these services can be applied to any manufacturer of wireless handsets across all frequency bands and radio access techniques. They can be applied to single mode, single band handsets up through multi-band, multi-mode handsets capable of global roaming.

These services can be operated simultaneously with other premium voice services over the wireless network. It is anticipated that “Virtual Push-to-Talk” and “Push-to-Share” will co-exist on the same wireless network, thereby leveraging the capital investment and operating cost

Network Architecture

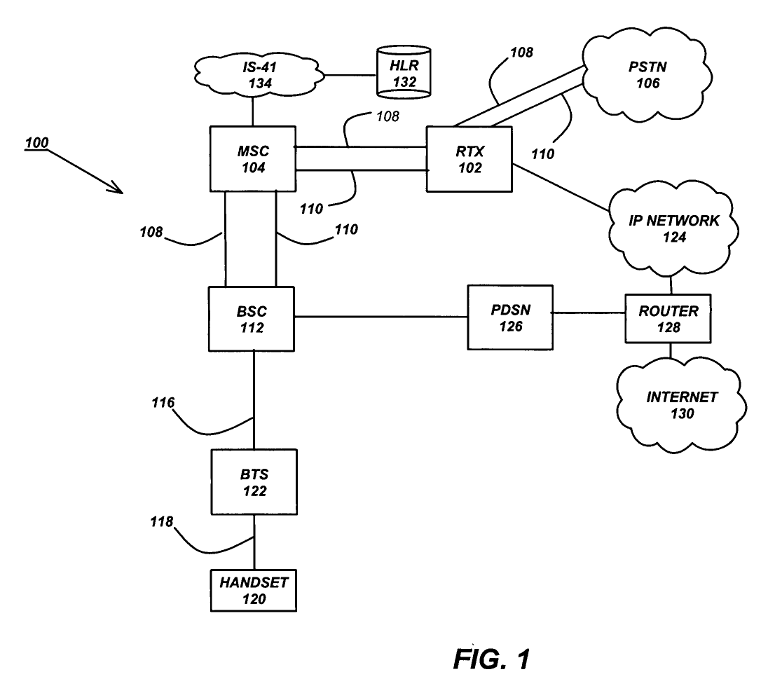

FIG. 1 is a block diagram that illustrates an exemplary embodiment of a wireless communications network according to a preferred embodiment of the present invention.

Within the network 100, an RTX (Real-Time Exchange) 102, previously known as a Dispatch Gateway (DG), communicates with a MSC (Mobile Switching Center) 104 and PSTN (Public Switched Telephone Network) 106 using SS7—ISUP/WIN/CAMEL (Signaling System 7—Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of an AVS call. The use of TFO ensures high voice quality (as voice codec conversion is avoided) between mobile-to-mobile calls.

When a subscriber originates an AVS call, the MSC 104 routes the call to the RTX 102. The MSC 104 also requests the BSC 112 via 116 to establish a radio traffic path 118 with the mobile handset 120 via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the AVS call request to the RTX 102), the RTX 102 identifies each terminating handset 120 and their MS-ISDN (Mobile Station ISDN Number) number. It sends a ISUP call origination request for each terminating handset 120. It may send requests directly to the MSC 104, PSTN 106 or IP network 124 via a PDSN (Public Data Switched Network) 126, Router 128, and/or Internet/Intranet 130, depending on the routing table configuration for terminating MS-ISDN numbers. Once the bearer path 110 is established, the RTX 102 begins a negotiation with the far end (in this case, the terminating BSC 112) for each terminating leg to a handset 120.

Once bearer paths 110 are established for originating and terminating legs for an AVS call, the RTX 102 switches (or duplicates) voice frames from the originating handset 120 to all terminating mobiles 120.

The RTX 102 may use an IP network 124 or the Internet/Intranet 130 for two different purposes. The IP network 124 or the Internet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Internet/Intranet 130 can also be used for a registration and presence application. Since the MSC 104 will not direct a registration request from a handset 120 to the RTX 102 (because it would require changes in the MSC 104), the latter does not have any information of the registered mobiles 120. To circumvent this issue, a registration and presence application runs over an IP stack in the handset 120. After the handset 120 registers for a data interface (i.e., obtaining an IP address) with the PDSN 126, the registration and presence application in the handset 120 registers with the RTX 102 using its IP address. The RTX 102 also uses this IP interface to update the presence information of other group members to a handset 120. There is also provision to use SMS (Short Message Service) transport to carry presence messages if an operator chooses to use SMS over a data channel.

During roaming, a Home Location Register (HLR) 132 can be accessed via the MSC 104 and an IS-41 link 134. The HLR 132 can be used to track the presence of members of a group within the network and updates the mobiles 120 for those members with the network availability of other members of the group.

Real Time Exchange

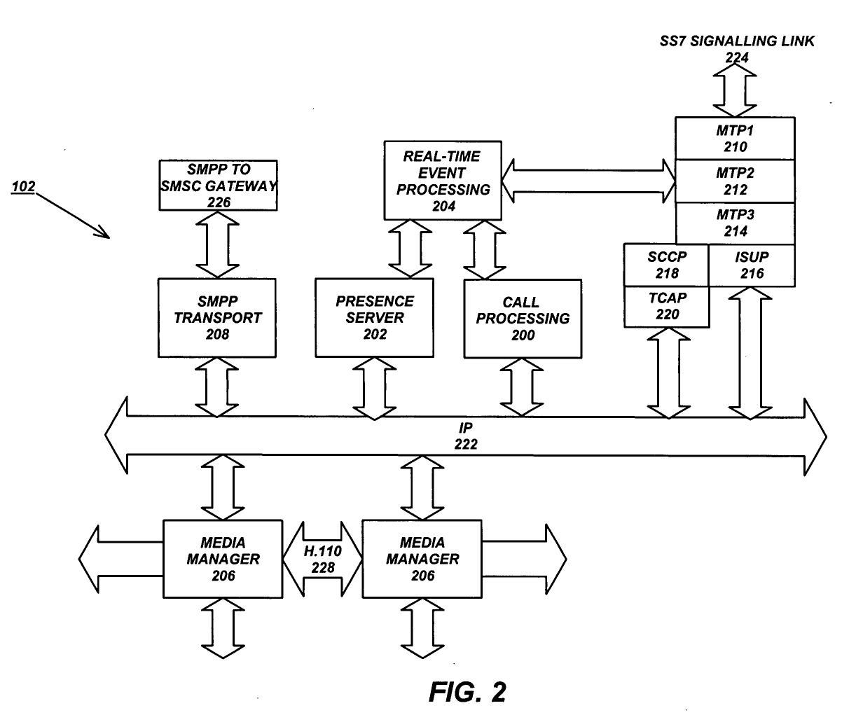

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228.

Virtual PTT Call within a Group PTT Call

The Virtual Push-to-Talk (PTT) is a value-added feature, which provides advanced call handling capability to the user. Specifically, the Virtual PTT allows a sub-group of a group to initiate a PTT sub-session or sidebar within a PTT session of the group. Consequently, the Virtual PTT allows the user to have more control over PTT calls, and also to enjoy privacy within the PTT calls.

The Virtual PTT is invoked while a user is engaged in a first 1 Many PTT session. The Virtual PTT is a second 1:Many (or 1:1) PTT session that comprises a sub-session or sidebar within the first 1:Many PTT session. The Virtual PTT is joined among some subset of the members of the group in the first 1 Many PTT session. Upon completion of the Virtual PTT, the users may re-join the first 1 Many PTT session.

For example, a subset of the members in a group call may want to have a 1:1 or a 1:Many sidebar, while the remaining members of the group carry on their discussions. Upon completion of the sidebar, the subset of the members rejoin the original group call. Consequently, the subset of the members do not release the original group call, but can rejoin the original group call after completing their sidebar.

This kind of call will simulate a real meeting, in which a couple of people step out of the meeting room for a sidebar, converse, and then rejoin the meeting. In the prior art, however, there is no ability to have sidebar or sub-sessions. Instead, if such a requirement is there, the concerned members need to make another call to those members, or ask the other members to get off the call.

To implement the Virtual PTT, the RTX 102 already has a CIC (Circuit Identity Code) setup in place, so the call legs for the Virtual PTT have to be chosen on demand and connected. In addition, the handset 120 provides the user with an option to initiate or join a Virtual PTT subs-session without interrupting the original PTT session, as well as an option for terminating the Virtual PTT sub-session and rejoining the original PTT session.

Alternative embodiments may provide other features as well. For example, the users can be provided further options to sync up with offline members using SMS while participating in the PTT session, to play voicemails while participating in the PTT session, etc.

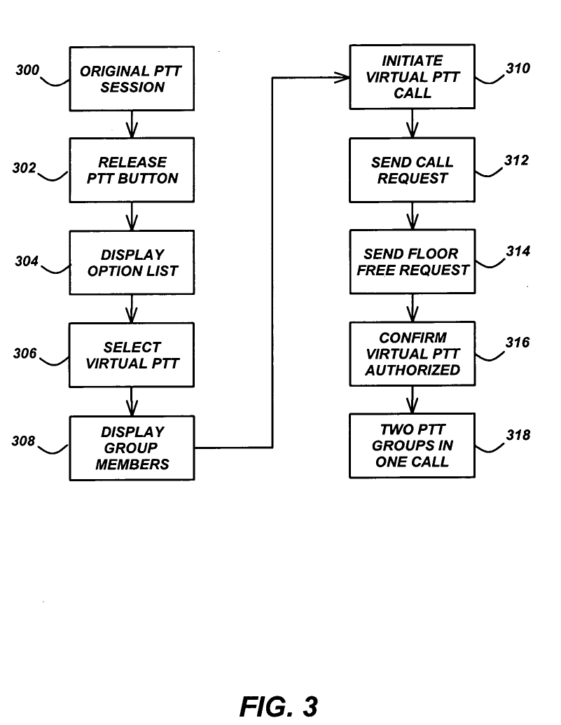

FIG. 3 is a flowchart that illustrates the operation requirements of the Virtual PTT, as described below.

Block 300 represents a first mobile station (MS1) participating in a first PTT session.

Block 302 represents the MS1 releasing the PTT button, and relinquishing the floor of the first PTT session.

Block 304 represents the user interface of MS1 displaying an option list for:
a. Release the Floor
b. Virtual PTT Call

Block 306 represents the user selecting option b.

Block 308 represents the user interface of MS1 displaying the group members list for the first PTT session.

Block 310 represents the user selecting one or more group members for the Virtual PTT sub-session and initiating the Virtual PTT sub-session.

Block 312 represents an in-band Virtual PTT call request being sent to the RTX 102, which transmits a tone or announcement to the selected group members.

Block 314 represents an in-band “floor free” request (call end request) for the first PTT session being sent to the RTX 102, so that the other members of the first PTT session can take control of the floor and continue the first PTT session.

Block 316 represents the MS1 receiving a tone from the RTX 102, which confirms the Virtual PTT calling authorization.

Block 318 represents two PTT groups existing within the same PTT call, i.e., the original PTT call and the Virtual PTT call. The user can select the PTT button on MS1, and his voice is multiplexed to the selected group members in the Virtual PTT call, wherein normal PTT rules apply within the Virtual PTT session. In the original PTT session, normal PTT rules also apply.

Push to Share (PTS)

The Push-to-Share (PTS) is a value-added feature, which provides advanced information sharing among group members, using the click of a button. The information being shared is communicated by SMS, and may comprise any number of different types of data. In the prior art, groups are created only for purposes of making calls or conferences, but quickly become disjoint. The PTS, on the other hand, aims to bring the group members together and provide them with value-added information sharing options.

Preferably, the PTS uses the functionality of the Press-to-Message (P2M) service described in co-pending and commonly-assigned PCT International Patent Application Number PCT/US04/23038, filed Jul. 16, 2004, by F. Craig Farrill, Bruce D. Lawler and Krishnakant M. Patel, entitled “PREMIUM VOICE SERVICES FOR WIRELESS COMMUNICATIONS SYSTEMS,” attorney docket number 154.7-WO-U1, which application is set forth above, and incorporated by reference herein. The P2M service uses the MMS (Multi Media Services) protocol as the transport medium. The P2M service delivers multimedia messages (e.g., audio, video, images, data, etc.), known hereafter as P2M messages from an originator to one or more recipients.

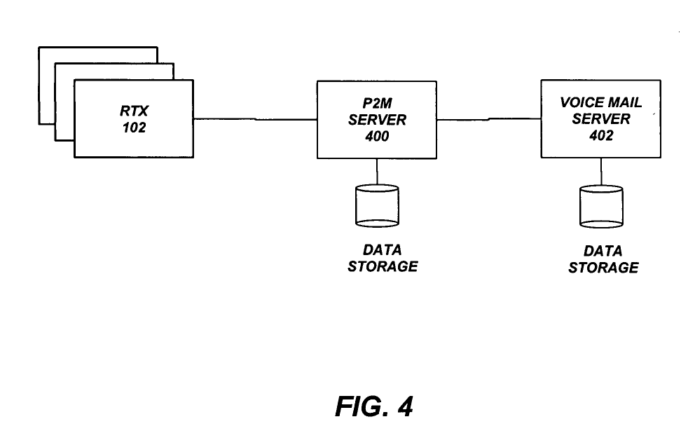

FIG. 4 illustrates a system architecture for the PTS service according to the preferred embodiment of the present invention. The system architecture includes one or more RTXs 102 coupled to a P2M server 400, which is (optionally) coupled to a Voice Mail Server 402, wherein the RTX 102 and the P2M Server 400 work together to deliver P2M messages in a non-real time manner from an originator to one or more recipients, without establishing voice paths between the originator and recipients. Recipients may comprise one or more contacts, one or more groups of contacts, or a subset of a group of contacts.

The P2M Server 400 provides a message storage facility for P2M messages, and may interface to the Voice Mail Server 402 to provide a message storage facility for the multimedia messages. The user can store P2M messages in the P2M Server 400, retrieve P2M messages from the P2M Server 400, and reply to the messages, or forward the messages to other P2M subscribers. The P2M service supports the sending of P2M messages to one or more contacts, one or more groups of contacts, or a subset of a group of contacts.

In the present invention, group members have a common data store for sharing information with each other. This information can of different types, including, but not limited to the following:
1. Group Notes. Members are able to write notes for the other group members to pick up.
2. Group Reminders. The owner/members can set up reminders for the group for certain occasions, e.g., birthdays, anniversaries, etc., and all of the members of the group are notified of the occasion, when it comes. This reminder can be in the form of a network initiated call, or an SMS, or a courtesy call from customer service.
3. Group Alarms. The owner/members can set up group alarms for the group for a certain time, e.g., a Project Meeting alarm, a Client meeting alarm, etc.
4. Phone Book. Phone book entries or contact lists may be shared among group members or a master phone book can be maintained.
5. Multimedia. Various common multimedia files may be shared among the members of the group.
6. Group Inbox. This could be an entry point to address the group as a whole.

This could be a very useful feature for presence applications, because the whole group can be addressed using this inbox.

For example, the P2M Server 600 may include the following PTS folders for a group identified as “Friends”:
Group “Friends”
/Group photos
   “John's Picnic Photos”
   “Smith's Family Photos”
/Group Reminders
   “Lance's Birthday”
   “Townhall Alumni Party”
   “Group Get-together”
/Group Notes
   “My visit to Brooklyn—By Smith”
   “Driving directions for John's home”
/Group Phonebook
   “John's Office phonebook”
   “Lance's folk's phonebook”
/Group Inbox
   “Server Notification—No more contacts can be added to this group”
   “Marketing mails also can be put here”

If one member pushes some data using PTS, the RTX 102 and the P2M Server 600 notify the other group members, by sending URLs or hyperlinks to the handsets 120 of the group members. The group members can then access the data by invoking the URLs or hyperlinks.

### CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing advanced voice services in a wireless network, comprising:
a Real-Time Exchange (RTX) that interfaces to the wireless network to provide a Virtual Push-to-Talk (PTT) sub-session between members of a group within a PTT session.

2. The apparatus of claim 1, wherein the Virtual PTT sub-session allows a sub-group of the group to privately converse within the PTT session.

3. The apparatus of claim 1, wherein the Virtual PTT sub-session is invoked while the members of the group are engaged in a first 1:Many PTT session.

4. The apparatus of claim 3, wherein the Virtual PTT subs-session is a second 1:Many or 1:1 PTT session that comprises a sidebar within the first 1:Many PTT session.

5. The apparatus of claim 3, wherein the Virtual PTT sub-session is joined among a subset of the members of the group in the first 1:Many PTT session.

6. The apparatus of claim 5, wherein, upon completion of the Virtual PTT sub-session, the subset of the members of the group re-join the first 1:Many PTT session.

7. A method for providing advanced voice services in a wireless network, comprising:
providing a Virtual Push-to-Talk (PTT) sub-session between members of a group within a PTT session using a real-time exchange that interfaces to the wireless network.

9. The method of claim 7, wherein the Virtual PTT sub-session allows a sub-group of the group to privately converse within the PTT session.

10. The method of claim 7, wherein the Virtual PTT sub-session is invoked while the members of the group are engaged in a first 1:Many PTT session.

11. The method of claim 10, wherein the Virtual PTT subs-session is a second 1:Many or 1:1 PTT session that comprises a sidebar within the first 1:Many PTT session.

12. The method of claim 10, wherein the Virtual PTT sub-session is joined among a subset of the members of the group in the first 1:Many PTT session.

13. The method of claim 12, wherein, upon completion of the Virtual PTT sub-session, the subset of the members of the group re-join the first 1:Many PTT session.

14. An apparatus for providing group voice services in a wireless network, comprising:
a Real-Time Exchange (RTX) coupled to a Push-to-Message (P2M) server, wherein the RTX and P2M Server interface to the wireless network, and the RTX and the P2M server work together to provide a Push-to-Share (PTS) service for sharing information among members of a group, wherein the members of the group have a common data store on the P2M Server for sharing information with each other.

15. The apparatus of claim 14, wherein the shared information comprises group notes, group reminders, group alarms, phone book entries, contact lists, or a group inbox.

16. The apparatus of claim 14, wherein the P2M Server includes PTS folders for the group.

17. The apparatus of claim 14, wherein when one member of the group pushes data using the PTS, other members of the group are notified by sending links to the handsets of the other members of the group, so that the other members of the group can access the data by invoking the links.

18. A method for providing group voice services in a wireless network, comprising:
providing a Push-to-Share (PTS) service for sharing information among members of a group using a Real-Time Exchange (RTX) coupled to a Push-to-Message (P2M) server, wherein the RTX and P2M Server interface to the wireless network, and the members of the group have a common data store on the P2M Server for sharing information with each other.

19. The method of claim 18, wherein the shared information comprises group notes, group reminders, group alarms, phone book entries, contact lists, or a group inbox.

20. The method of claim 18, wherein the P2M Server includes PTS folders for the group.

21. The method of claim 18, wherein when one member of the group pushes data using the PTS, other members of the group are notified by sending links to the handsets of the other members of the group, so that the other members of the group can access the data by invoking the links.
